(19) United States
(12) Patent Application Publication
(10) Pub. No.: US 2021/0226228 A1
(43) Pub. Date: Jul. 22, 2021

(54) ENERGY GENERATION OR ENERGY STORAGE SYSTEM

(71) Applicant: THE SUN COMPANY TEXAS, LLC d.b.a. THE SUN COMPANY, Tucson, AZ (US)

(72) Inventors: Ryan G. Redford, Irvine, CA (US); Daniel Carothers, Lucas, TX (US)

(73) Assignee: THE SUN COMPANY TEXAS, LLC d.b.a. THE SUN COMPANY, Tucson, AZ (US)

(21) Appl. No.: 17/150,185

(22) Filed: Jan. 15, 2021

Related U.S. Application Data
(60) Provisional application No. 62/962,735, filed on Jan. 17, 2020.
(60) Provisional application No. 62/962,743, filed on Jan. 17, 2020.

(51) Int. Cl. H01M 8/0232; H01M 8/0245; H01M 4/92; H01M 10/0525; H01M 4/38; H01M 4/36; H01M 4/134; H01M 4/131

(52) U.S. Cl. CPC H01M 8/0232; H01M 8/0245; H01M 4/926; H01M 10/0525; H01M 2004/8684; H01M 4/366; H01M 4/134; H01M 4/131; H01M 4/386

(57) ABSTRACT

Disclosed is a Proton Exchange Membrane Fuel Cell (PEMFC) incorporating a porous membrane element formed of a porous silicon wafer, in which the pores are coated at least in part with a noble metal. Alternatively, the porous silicon wafer may be sandwiched between paper, carbon or graphite sheet impregnated with a noble metal. The separator is formed of using MEMS Technology. Also disclosed is a lithium ion battery, has a cathode electrode; an anode electrode formed of a porous silicon substrate in which surfaces of the pores of the porous silicon substrate are coated at least in part with a metal silicide; a separator element disposed between the cathode and the anode; and an electrolyte.

### CROSS-REFERENCE TO RELATED APPLICATIONS

This application claims priority from the U.S. Provisional Application Ser. No. 62/962,735, filed Jan. 17, 2020; and U.S. Provisional Application Ser. No. 62/962,743, filed Jan. 17, 2020, the contents of which are incorporated herein in their entirety, by reference.

The present disclosure, in one aspect relates to improvements in lithium ion batteries, and in another aspect to improvements in fuel cells. In both aspects, the improvements involve the incorporation of a porous silicon substrate material as an anode electrode in the case of a lithium ion rechargeable battery, or as a proton exchange membrane in the case of a fuel cell.

### FIELD OF THE DISCLOSURE

The present disclosure in one aspect relates to a proton exchange membrane fuel cell and a method of forming a fuel cell, and more specifically to a proton exchange membrane fuel cell which includes a novel membrane formed of porous silicon material, and a method of forming a novel porous silicon membrane for use in a proton exchange membrane fuel cell. In another aspect, the present disclosure relates to lithium ion rechargeable batteries having anode electrodes formed of a porous silicon substrate coated at least in part with a metal silicide.

### BACKGROUND OF THE DISCLOSURE

Fuel cells, and particularly, proton exchange membrane fuel cells (PEMFCs) are attractive due to their high theoretical efficiency and to the non-polluting nature of reaction byproducts.

Further, PEMFC's provide a large power range, which makes them suitable for stationary applications, such as high-power installations for electric power generation, as well as for electric vehicles, or any other device requiring an autonomous power source (electric generating unit, portable electronic device, etc.).

Generally, a PEMFC operates by oxidation of a fuel (hydrogen or methanol, for example) at the anode, and by proton transfer from the anode to the cathode through the proton exchange membrane. The electrons resulting from the oxidation reaction are conveyed back to the cathode via an external circuit, wherein the chemical energy is converted into electric energy and into heat.

PEMFC's have many advantages, such as a lack of sensitivity to carbon dioxide; a relatively low operating temperature which allows a fast start; a flexibility of use and of heat management; a decrease of electrode corrosion problems; and a lack of leakage of the electrolyte.

However, PEMFC's also have disadvantages such as a high sensitivity to carbon monoxide; a relatively low operating temperature (lower than 100° C.), which does not enable effective use of the generated heat; and an expensive noble metal catalyst (generally based on platinum).

Useful membranes for PEMFC's must be impermeable to gases, have good mechanical properties and a high proton conduction. Further, they should be thin, typically having a thickness of a few microns. Finally, the membrane should be made of electrochemically and chemically stable material.

Currently, membranes for PEMFC's are formed of perfluorosulfonate type ionomers (PFSA), such as Dupont's Nafion® and Solvay Specialty Polymers' Aquivion®. In such perfluorosulfonate ionomers, the proton conductivity of the membrane is ensured by —SO₃H groups (sulfonic acid function).

However, such membranes have disadvantages due to their permeability to methanol and to hydrogen. Further, their mechanical properties degrade beyond their optimal operating temperature (80° C.). This is particularly constraining for the automobile field, for example. Indeed, for this type of application, a PEMFC operating between −30 and 120° C., and in the presence of slightly humidified gases (between 0 and 50% of relative humidity) is required.

The performance of a PEMFC also is linked to other issues, including:
the presence of carbon monoxide (CO) generally causes a poisoning of the catalysts. When the hydrogen (fuel) is obtained by reforming, it generally contains traces of carbon monoxide. The presence of CO lowers the efficiency of a platinum-based catalyst which adsorbs it. The performance of the PEMFC thus is lowered. On the other hand, the adsorption of CO on a platinum-based catalyst is favored at low temperature, but affected at high temperature due to negative entropy of the adsorption reaction. Thus, tolerance to CO increases with temperature. The performance degradation of the PEMFC due to the CO poisoning may thus be significantly attenuated at high temperature (approximately 140° C.).
thermal management of a PEMFC is more complicated at low temperature, given that a typical PEMFC generates from 40 to 50% of its energy in the form of heat. Accordingly, when the cell operates at low temperature, large quantities of energy have to be dissipated. Conversely, when the cell operates at temperatures in the range from 120 to 140° C., the heat generated by the cell enables me to maintain the system temperature and requires smaller cooling systems. This point is particularly important for an application in the automobile industry. Further, for temperatures higher than 100° C., generated heat may also be used for other purposes (heating in cogeneration mode, for example).
humidification of the membrane is essential at low temperature, given that conventional PFSA-type membranes require being constantly hydrated. The additives necessary for the humidification complicate and decrease the reliability of the system. The humidification is necessary given that the proton conductivity of the membrane increases with the quantity of water contained in the polymer matrix, which itself increases with the quantity of water outside of the membrane (relative humidity). Such a humidification is all the more complex to achieve and to manage and requires all the more energy as the temperature is high.

There exists a need to develop a PEMFC membrane capable of being used at low temperature as well as at high temperature with gases having a low water content (<50% of relative humidity).

Also, demand for high capacity rechargeable batteries is strong and increasing each year. Many applications, such as aerospace, medical devices, portable electronics, and automotive applications, require high gravimetric and/or volumetric capacity cells. Lithium ion electrode technology find significant application in this area. However, to date, lithium ion cells employing graphite electrodes are limited to theoretical specific energy density of only 372 mAh/g.

Silicon is an attractive active electrode for use in lithium ion batteries material because of its high electrochemical capacity. Silicon has a theoretical capacity of about 4200 mAh/g, which corresponds to the Li_{4.4}Si phase. Yet, silicon is not widely used in commercial rechargeable lithium ion batteries. One reason is that silicon exhibits substantial changes in volume during charging and discharging cycling. For example, silicon may swell by as much as 400% when charged to its theoretical capacity. Volume changes of this magnitude can cause substantial stresses in the active material structures, resulting in fractures and pulverization, loss of electrical and mechanical connections within the electrode, and capacity fading.

Conventional rechargeable lithium ion battery electrodes typically include polymer binders that are used to hold active materials on a carbon or graphite substrate. However, most polymer binders are not sufficiently elastic to accommodate the large swelling of some high capacity materials. As a result, active material particles tend to separate from each other and the current collector. Overall, there is a need for improved applications of high capacity active materials in rechargeable lithium ion battery electrodes that minimize the drawbacks described above.

U.S. Pat. Nos. 8,257,866 and 8,450,012 propose addressing the elasticity and swelling problems of prior art rechargeable lithium ion battery electrode materials by providing an electrochemically active electrode material comprising a high surface area template containing a metal silicide and a layer of high capacity active material deposited over the template. The template reportedly serves as a mechanical support for the active material and/or an electrical conductor between the active material and, for example, the substrate. According to the inventors of the '866 and '012 patents, due to the high surface area of the template, even a thin layer of the active material can provide sufficient active material loading and corresponding electrode capacity per surface area. As such, the thickness of the active material layer theoretically may be maintained sufficiently small to be below its fracture threshold to preserve its structural integrity during battery cycling. The thickness and/or composition of the active layer also may be specifically profiled to reduce swelling near the substrate interface and preserve the interface connection.

### SUMMARY OF THE DISCLOSURE

The present disclosure in one aspect provides a PEMFC membrane capable of being used of a wide temperature range and wide relative humidity ranges.

More particularly, the present disclosure provides a novel porous silicon wafer substrate material and a method for forming novel porous silicon wafer substrate material and the use thereof as a membrane in a PEMFC. More particularly, the present disclosure provides a method for forming novel porous silicon wafers for use as membrane separators for PEMFC's using MEMS (microelectromechanical systems) technology. In accordance with the present disclosure, a silicon wafer is selectively masked using resist deposition and photolithography techniques and selected portions of the wafer are subjected to electrochemical etching to form pores or channels extending through the silicon wafer. Preferably, the channels or pores are substantially cylindrical in shape, and have a relatively high, (e.g., >50:1) length to cross section diameter aspect ratios.

In one embodiment, pore size, membrane selectivity and ion conductivity are “tuned” by inorganic doping of the silicon wafer to allow only positively charged ions to pass through the membrane to the cathode when the membrane is used as a separation barrier in a PEMFC.

The present disclosure also provides PEMFC's in which the novel porous silicon wafers are used as membrane materials. More particularly, the present disclosure provides a PEMFC comprising a separator membrane element formed of a porous silicon wafer.

In one embodiment, pores of the porous silicon wafer are substantially cylindrical through-holes. Preferably, the cylindrical through-holes have a length to diameter aspect ratio of >50:1 although other aspect ratios are contemplated as a function of application.

In another embodiment surfaces of pores of the porous silicon wafer are treated to enhance surface ion conductivity. For example, the surfaces of the pores may be modified by deposition of a noble metal catalyst, preferably platinum.

The present disclosure also provides a PEMFC comprising an electrical assembly comprising cathode (positive) and anode (negative) electrodes respectfully located in a fuel cell and including a proton exchange membrane formed of a porous silicon wafer, sandwiched between two noble metal catalyst coated porous sheets.

In one particular embodiment of the PEMFC, the catalyst comprises a noble metal, preferably platinum.

Also, in the case of lithium ion rechargeable batteries, in order to overcome the aforesaid and other problems in the prior art, we provide high surface area porous silicon substrate materials for forming anode electrodes for rechargeable lithium ion batteries. More particularly, in accordance with the present disclosure, silicon substrate material is subjected to an electrochemical etching to form interconnected nanostructures or through holes or pores through the silicon substrate material. Thereafter, an electrochemically active material such as a metal silicide is formed on surfaces of the pores of the silicon substrate material, for example, by depositing an appropriate metal such as titanium or tungsten or cobalt on the porous silicon substrate material (although other metals are contemplated as a function of application), using various deposition techniques including but not limited to chemical vapor deposition (CVD), plasma-enhanced chemical vapor deposition (PECVD), thermal CVD, electroplating, electroless plating, and/or solution deposition techniques, which are given as exemplary, and the metal-coating on the porous silicon substrate material is converted to the corresponding metal silicide by heating.

The resulting substrate is a porous silicon substrate which includes a metallurgically bonded surface layer of metal silicide on the walls of the porous structure, which advantageously may be used as an electrode in a rechargeable lithium ion battery.

While the resulting porous substrate material may be somewhat less efficient per charge volume than, for example, conventional carbon or graphite based electrodes used in rechargable lithium ion batteries, the porous structure provides several significant advantages. For one, the porous structure allows protons more time to move through the electrode matrix. As a result, swelling during a charging cycle is significantly reduced. Thus, the substrate is less likely to form dendrites or fractures during a charging cycle. Accordingly, charge and discharge rates may be increased without a danger of fracture or explosion. Furthermore, when used as an anode, the anode may be made significantly larger than the cathode resulting in further increases in overall performance.

The present disclosure also provides lithium ion batteries, comprising: a cathode electrode; an anode electrode formed of a porous silicon substrate in which surfaces of the pores of the porous silicon substrate are coated at least in part with a metal silicide; a separator element disposed between the cathode and the anode; and an electrolyte. The silicon substrate may comprise monocrystalline silicon, polycrystalline silicon, or amorpohous silicon. Preferably the pores have a length to diameter aspect ratio of >50:1, and the electrolyte comprises a conventional lithium salt electrolyte such as LiPF₆ or LiBF₄ in an organic solvent such as vinylene carbonate, 1,3-Propane sultone, 2-Propylmethanesulfate, Cyclohexylbenzene, t-Amylbenzene or Adiponitride which are given as exemplary.

In one embodiment the metal silicide coating is selected from the group consisting of TiSi₂, CoSi₂ and WSi₂ which are given as exemplary (although other metal silicides are contemplated as a function of application).

The present disclosure also provides an electrode for use in a lithium ion battery, wherein the anode electrode comprises a substrate formed of porous silicon in which surface areas of the pores are coated at least in part with a metal silicide. The silicon substrate may comprise monocrystalline silicon, polycrystalline silicon, or amorphous silicon, the pores have a length to diameter aspect ratio of >50:1, and the metal silicide preferably is selected from the group consisting of TiSi₂, CoSi₂ and WSi₂ which are given as exemplary (although other metal silicides are contemplated as a function of application).

### BRIEF DESCRIPTION OF THE DRAWINGS

Further features and advantages of the present disclosure will be seen from the following detailed description, wherein like numerals depict like parts, and wherein:

FIG. 1 is a schematic flow diagram showing formation of a porous silicon wafer useful as a membrane in a PEMFC in accordance with a first embodiment of the present disclosure;

FIGS. 2(a)-2(h) are cross-sectional views illustrating the silicon wafer at various stages of the process of FIG. 1;

FIG. 3 is a view, similar to FIG. 1, showing an formation of a porous silicon wafer useful as a porous membrane in a PEMFC in accordance with a second embodiment of the present disclosure;

FIG. 4(a)-4(k) are cross-sectional views illustrating the silicon wafer at various stages of the process of FIG. 3;

FIGS. 5(a)-5(d) are schematic cross-sectional views showing formation of a porous silicon wafer made in accordance with another embodiment of the present disclosure;

FIG. 6 is a schematic view of a PEMFC in accordance with the present disclosure;

FIG. 7 is a schematic block diagram with a process for producing electrode material in accordance with one embodiment of the present disclosure;

FIGS. 8A and 8B are cross-sectional view of electrode material at various stages of production in accordance with the present disclosure;

FIG. 9 is a schematic block diagram of a process for producing electrode material in accordance with another embodiment of the present disclosure;

FIG. 10 is a schematic block diagram of a yet another process for producing electrode material in accordance with the present disclosure;

FIG. 11 is a cross-sectional view of a rechargeable battery made in accordance with the present disclosure;

FIG. 12 is a schematic block diagram of still yet another process for producing electrode material in accordance with the present disclosure;

FIG. 13 is a cross-sectional view of a rechargeable battery in accordance with the present disclosure; and

FIG. 14 is a perspective view of a battery made in accordance with the present disclosure.

### DETAILED DESCRIPTION OF THE PRESENT INVENTION

The terms “top” and “bottom” and “left” and “right” are employed in a relative, and not an absolute sense to facilitate description and to describe relative locations of elements. The terms can be used interchangeably.

Modes for carrying out the present disclosure will be described in detail below, with reference to the drawings.

### First Embodiment

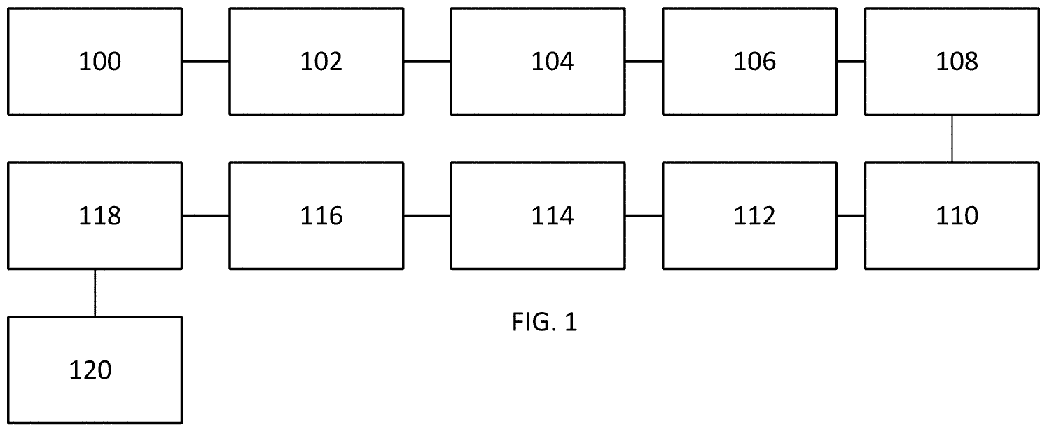

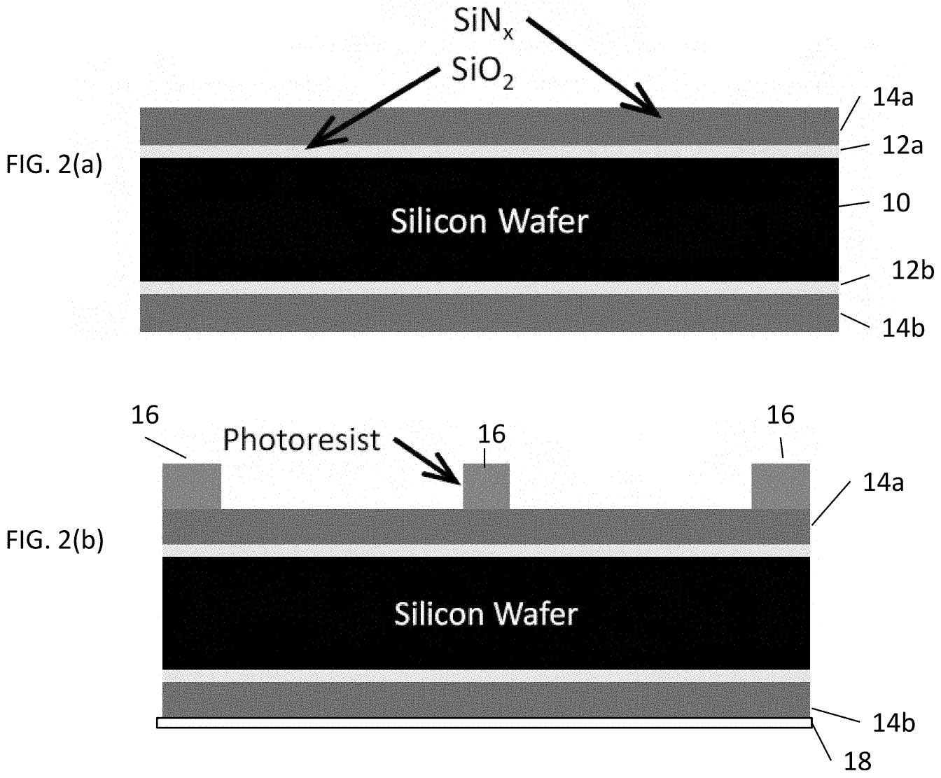

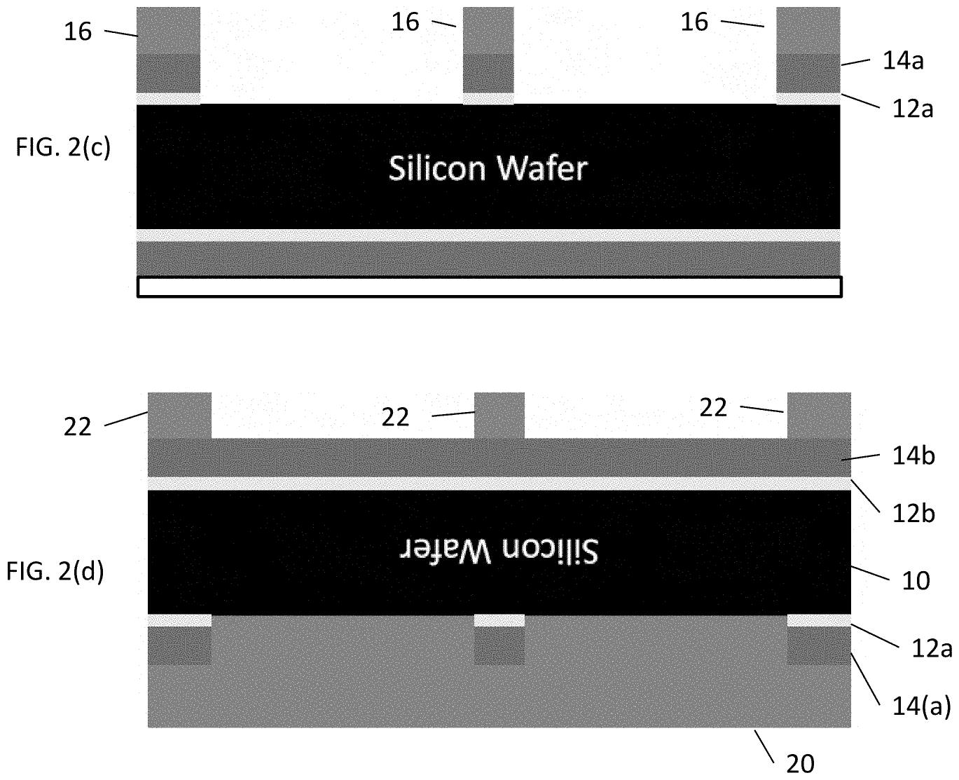

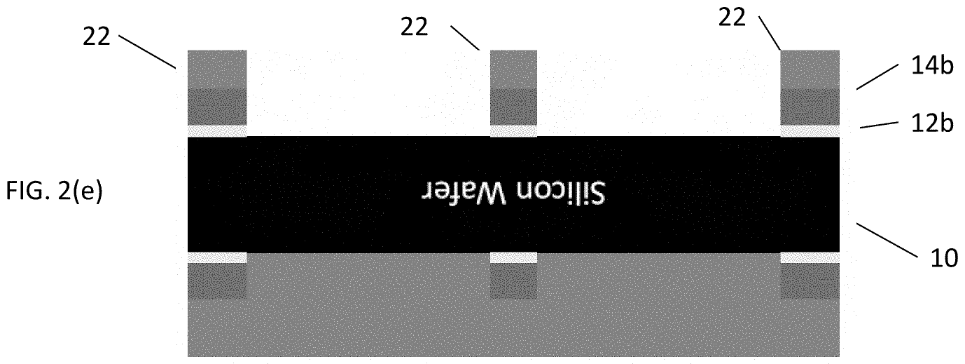

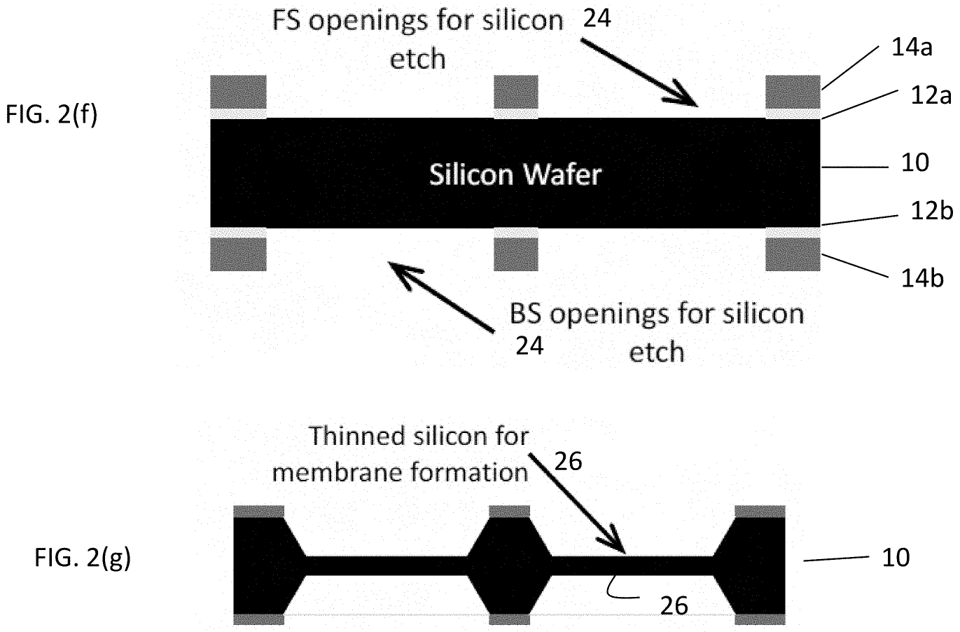

FIGS. 1 and 2(a)-2(h) are schematic and cross-sectional views showing the steps of manufacturing a porous silicon wafer according to a first embodiment of the present disclosure. In the drawings the cross-sectional dimension of the pores in the horizontal direction of the drawings figures are shown enlarged for clarity.

Referring to FIGS. 1 and 2(a)-2(h), starting with a silicon wafer 10, as shown in FIG. 2(a), dielectric materials are deposited in step 100 to form a hard mask on front and back sides of the wafer 10. In this case each side of the wafer will first be deposited with 50 nm layer 12a, 12b of SiO₂ followed by 300 nm layers 14a, 14b of SiNₓ.

Next, in step 102, the front side mask 14a is patterned with a photoresist 16 which is spun and patterned on the front side of the wafer, and a polymer material 18 is spun onto the back side of the wafer. Pattern 16 defines the hard mask etch which will in turn be used for a deep anisotropic etch. Alignment elements (not shown) for a subsequent backside etch are also formed at this step 102.

FIG. 2(c) shows a cross section of the wafer after the etch of the pad hardmask (step 104). Here a dry etch (plasma) is used to control the edges of the hardmask to ensure uniform edge erosion during KOH etch (although other etchants are contemplated as a function of application).

As shown in FIG. 2(d), the front side of the wafer has been spun with a polymer 20 at step 106 to protect the pattern on the front side while the pad structure on the back side is patterned at 22 in step 108. Alternatively, a back side hardmask could be deposited after the patterning of the front side. The back side pattern 22 is aligned to marks (not shown) formed on the front side of the wafer to ensure they are aligned.

After the back side pad structures are patterned at step 108, a dry etch (plasma) is used in step 110 to etch the dielectrics while controlling the edge shape. This is shown in FIG. 2(e).

FIG. 2(e) shows the nitride (PAD) etch of the back side pad structure, which is aligned to the front side pattern. This step is followed by a resist strip and wafer clean step 112 in preparation for wet etch of features.

FIG. 2(f) shows the configuration of the wafer after the resist strip and before KOH or other anisotropic etch in step 114. We prefer to use a wet etch so that both faces can be etched simultaneously to ensure the same etch depth on both sides. However, a plasma etch could be used to independently etch each face. The open areas 24 as delineated by the etching of the dielectrics are shown on each side of the wafer.

The next step 116 is to etch the silicon to thin it locally to create regions 26 for defining thinner silicon regions for formation of the porous silicon material in a subsequent step 118 as will be described below. This step preferably is conducted using a simple open bath etch, although a tool etch could be used. FIG. 2(g) shows the wafer after anisotropic wet etch 116.

The thinned or contoured silicon wafer from step 116, is then subjected to an electrochemical etching by applying uniform electrical field across the wafer while immersing the wafer in an etchant such a Dimethylformamide (DMF)/Dimethylsulfoxide (DMSO)/HF etchant in an electrochemical immersion cell, in an electrochemical etching step 118, to form through holes or pores 28 through the thinned section 26 as shown in FIG. 2(h) (although other etchants are contemplated as a function of application). The growth of well-defined cylindrical micropores or through holes can be controlled by controlling etching conditions, i.e., etching current density, etchant concentration, temperature, silicon doping, etc., following the teachings of Santos et al., Electrochemically Engineered Nanoporous Material, Springer Series in Materials Science 220 (2015), Chapter 1, the contents of which are incorporated herein by reference.

The resulting pores have a high aspect ratio of length to cross-sectional diameter typically a length to diameter aspect ratio of >50:1 (although other aspect ratios are contemplated as a function of application). The resulting structure, shown in FIG. 2(h) comprises a porous silicon wafer 30 having substantially cylindrical through holes or pores 28 having a length of, e.g., 180 μm and a diameter of 1.6 μm, i.e, an aspect ratio of 112.5:1 which is quite effective for use as a membrane in a PEMFC as will be described below (although other aspect ratios are contemplated as a function of application). The surfaces of the resulting porous silicon wafer 30 may then be coated with a noble metal at a step 120, and the resulting noble metal coated porous wafer 30 may be incorporated as a membrane in a PEMFC as will be described below.

### Second Embodiment

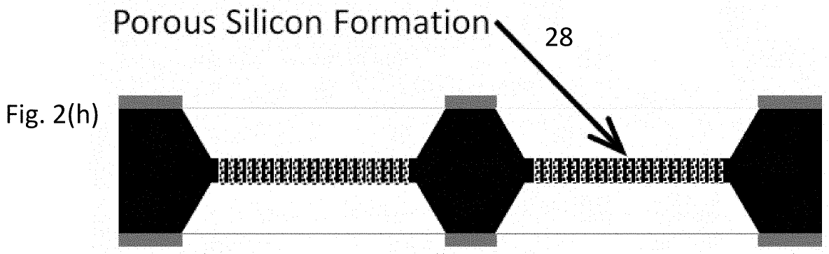

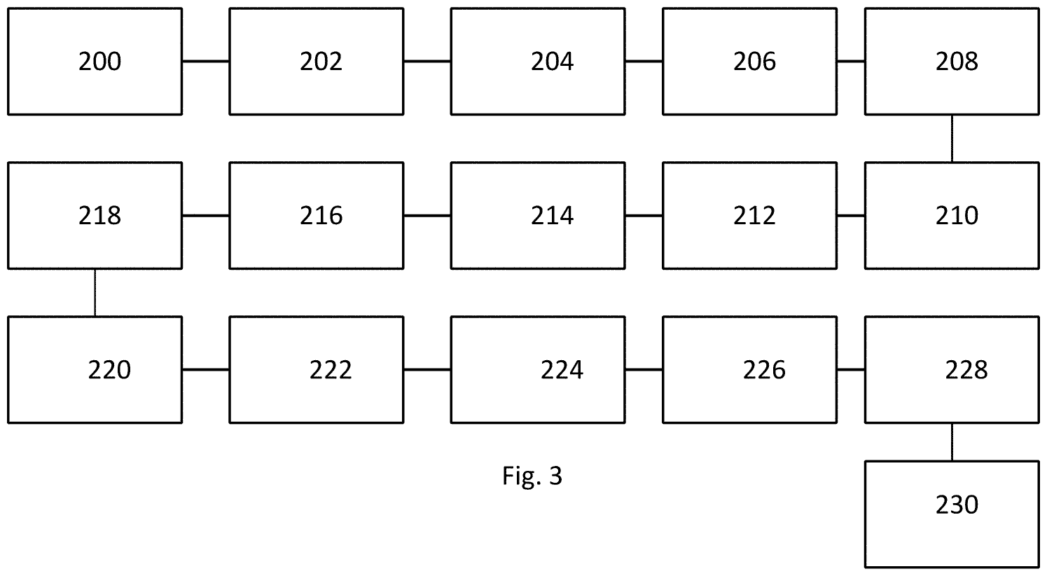

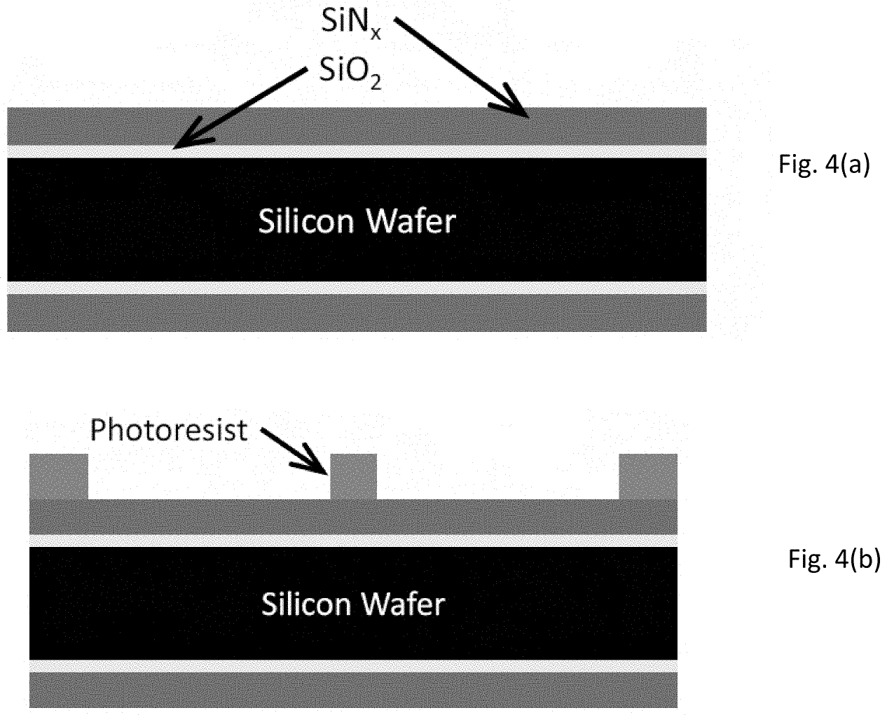

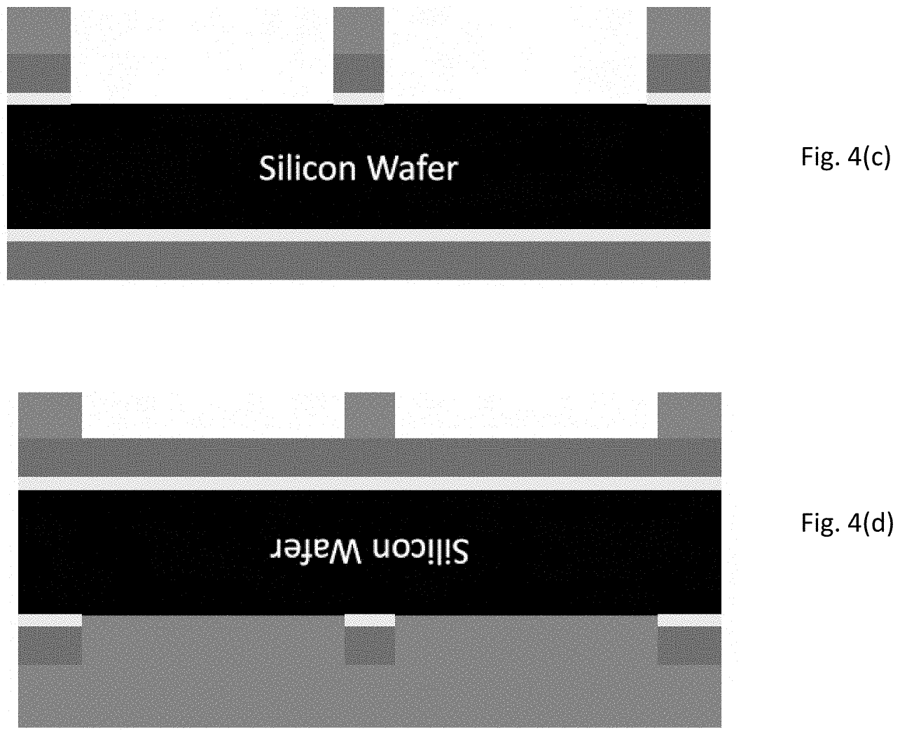

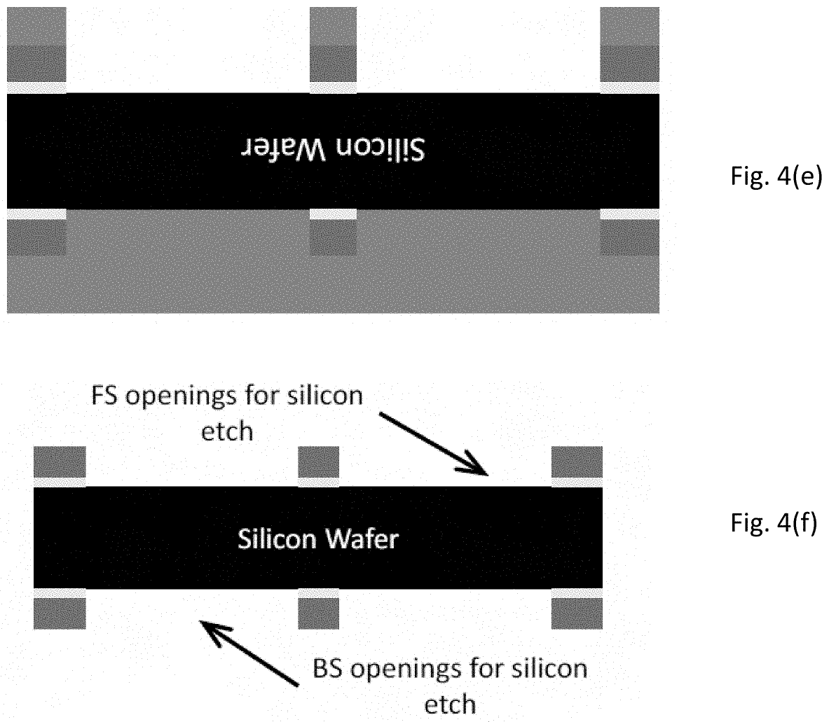

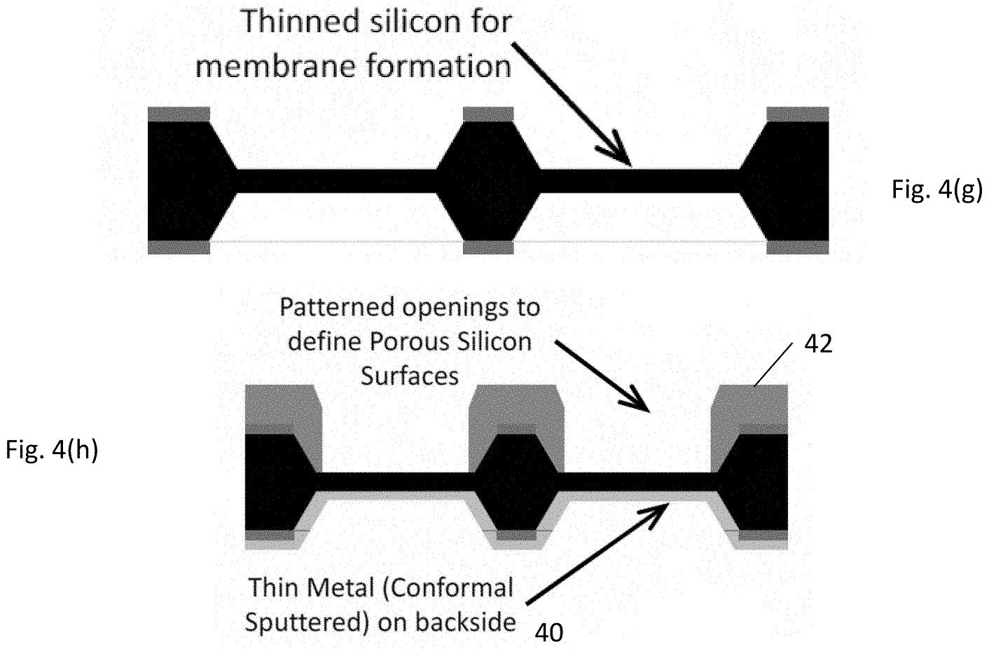

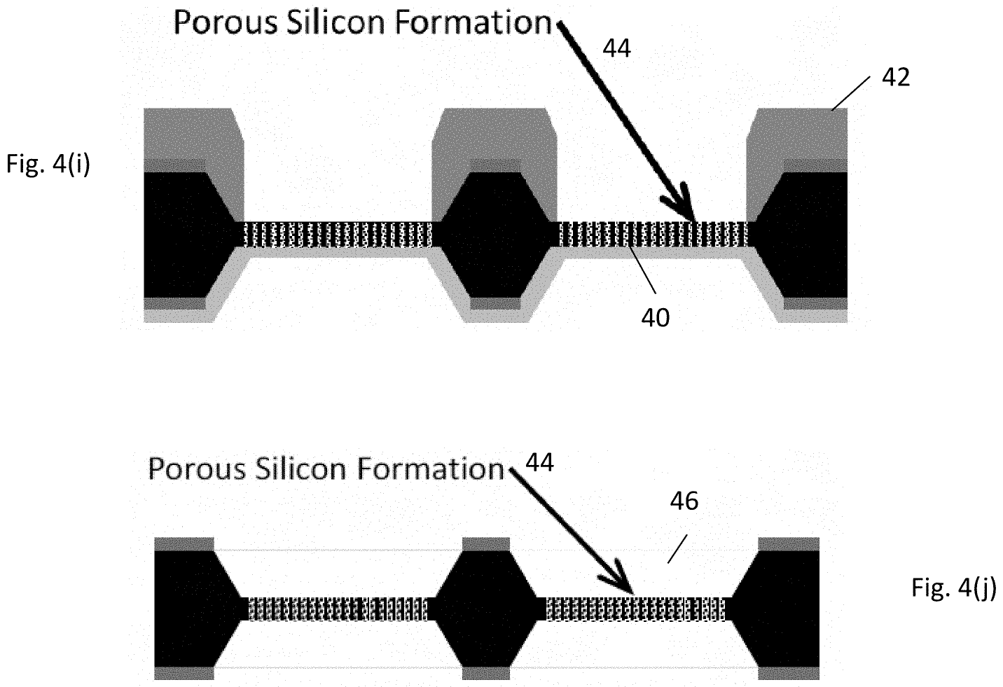

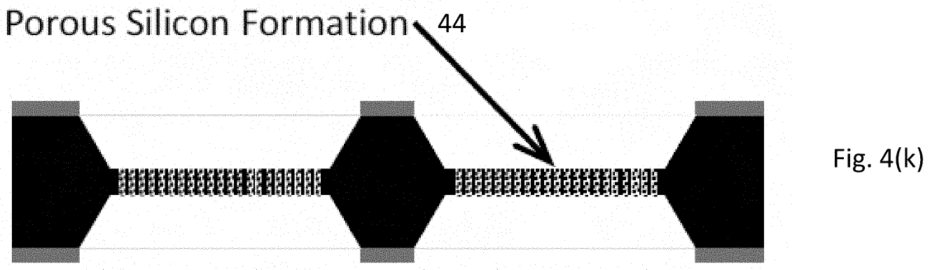

FIGS. 3-4 illustrate a second embodiment of the present disclosure. The process steps 200-216 of FIG. 3, and cross-sectional views of FIGS. 4(a)-4(g) are identical to process steps 100-116 of FIG. 1 and cross-sectional views 2(a)-2(g) above described.

However, referring to FIG. 4(h) upon completion of contouring etch step 216, we put a thin metal layer 40 on the back side of the contoured wafer e.g., by sputtering in a step 218 followed by a photolithographing resist step 220 on the front side of the contouring wafer. Metal layer 40 on the backside of the wafer promotes improved electrical contact to the wafer, while the resist 42 applied in the photolithography step 220 limits porous silicon formation to the thinned region 26 of silicon in the following etching step described below.

As shown in FIG. 4(i), an electro chemical etching (step 222) is used to form porous silicon 44 within the areas unprotected by the resist 42.

After porous silicon formation, step 222, the front side is protected by spinning a photoresist 46 on it in step 224 (see FIG. 4(j)) and a wet etch (step 226) is used to remove the thin metal 40 from the back side. The front side resist 46 is then striped in a resist stripping step 228. FIG. 4(k) shows the configuration after metal etch and photoresist strip. The pores may then be coated with a noble metal at step 230. Optionally, an additive process such as atomic layer deposition may be used to coat the surfaces of the pores or the pore diameters with a noble metal, before the stripping step 228. The resulting porous silicon wafer may then be incorporated as a membrane in a PEMFC as will be described below.

### Third Embodiment

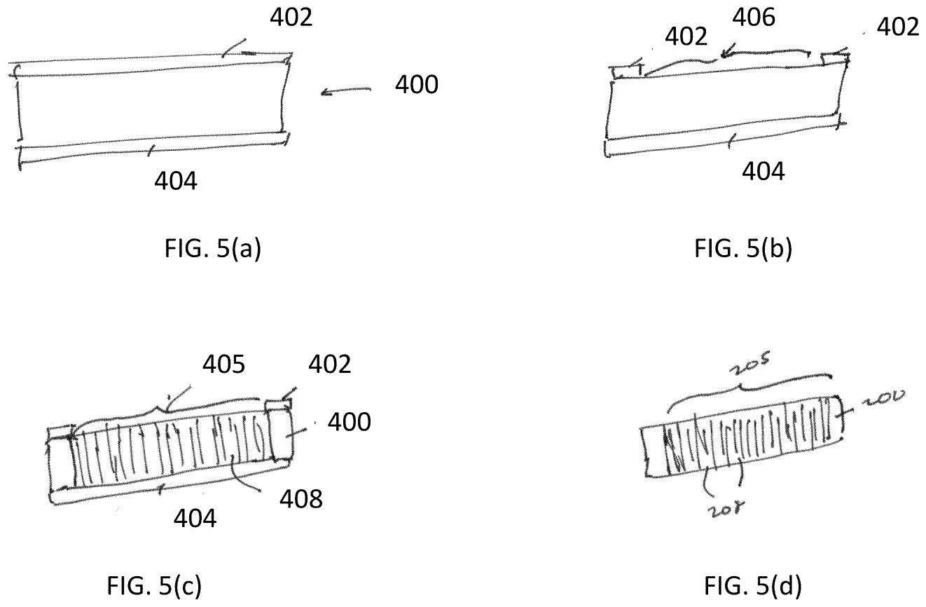

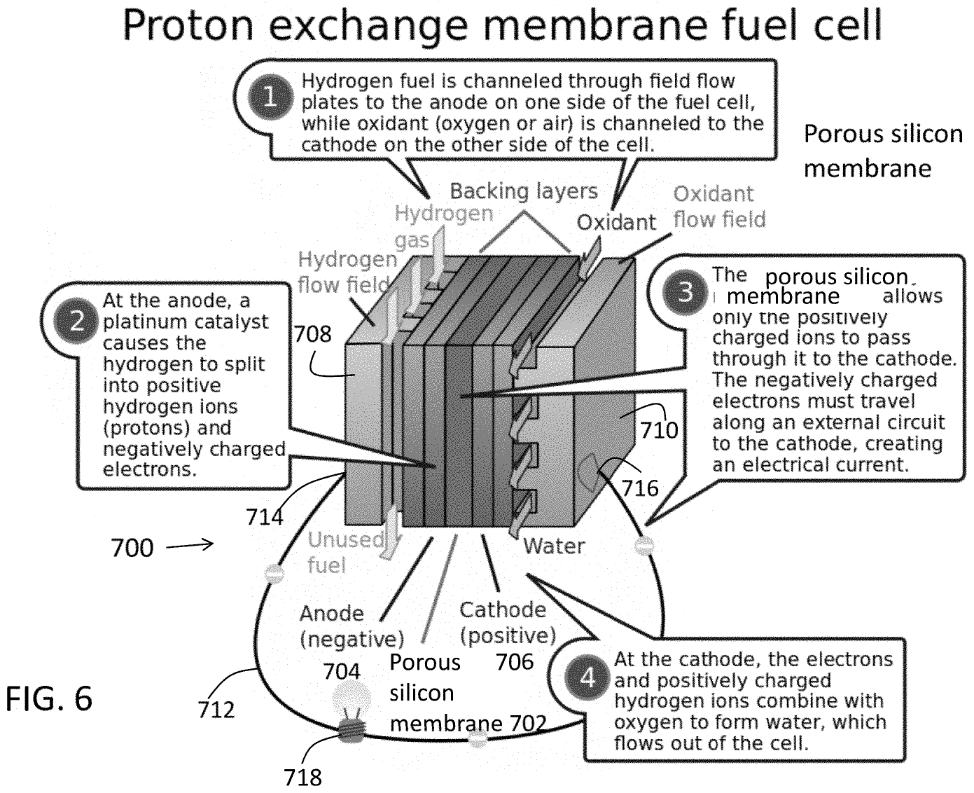

FIGS. 5-6 illustrate a third embodiment of the present disclosure. The process starts with a silicon wafer 400 covered on one side with a resist layer 402, and covered on the opposite side by a sacrificial metal layer 404 formed of, for example, a noble metal such as platinum (see step FIG. 5(a)) (although other metals are contemplated as a function of application). The resist layer 402 is patterned at step 502, and etched at step 504 to expose a selected surface 406 one side of the wafer 400 (FIG. 5(b)). The resist covered and patterned wafer is then subjected to electrochemical etching by applying an uniform electrical field across the metal layer 404 and substrate wafer 400 as the wafer is immersed in an electrochemical cell containing an etchant such as HF and H₂O₂, in step 506, whereby to produce substantially uniform pores 408 through the exposed portion of the substrate 400 to the metal layer 404 (FIG. 5(c)) (although other etchants are contemplated as a function of application). As before, the growth of well-defined cylindrical micropores with two holes can be controlled by controlling etching conditions, i.e., etching current density, etching concentration, temperature, silicon doping, etc., again following the teachings of Santos et al. Alternatively, micropore or through hole formation can be controlled by covering selected portions of the silicon wafer with a nanoporous anodic alumina mask (although other masks are contemplated as a function of application). Self-ordered nanoporous anodic alumina is basically a nanoporous matrix based on alumina that features closed-packed arrays of hexagonally arranged cells, at the center of which a cylindrical nanopore grows perpendicularly to the underlying aluminum substrate. Nanoporous anodic alumina may be produced by electrochemical anodization of aluminum, again following the teachings of Santos et al. the teachings of which are incorporated herein by reference. The resist layers 402 and sacrificial metal layer 404 can then be removed in a step 508 leaving a porous silicon wafer having a section 405 having substantially cylindrical through holes or pores 408 (FIG. 5) which may then be coated with a noble metal catalyst coating, and the resulting porous silicon substrate may be incorporated as a membrane in a PEMFC as will be described below.

The noble metal catalyst may be platinum black, platinum-on-carbon, and/or other composite noble metal material, e.g., silver, gold, rhodium, iridium, palladium, ruthenium and osmium (although other metal catalysts are contemplated as a function of application).

Referring now to FIG. 6, a PEMFC is assembled as follows:

The porous silicon membrane formed as above may be incorporated into a PEMFC module 700 which is schematically illustrated in FIG. 6. The PEMFC module 700 includes a porous silicon membrane 702 as formed above, sandwiched between an anode or negative electrode 704, and a cathode or a positive electrode 706. The anode/membrane/cathode sandwich is in turn sandwiched between hydrogen gas flow channel or plate assembly 708 on the anode side, and an oxidant (oxygen or air) of flow channel or plate assembly 710 on the cathode side. The assembly is held together in a case (not shown) which includes fittings for flowing the oxygen hydrogen gas and oxidate, a sump and drain (not shown) for draining water which is formed by reaction of the hydrogen gas an oxidate, and an electric circuit 712 including electrodes 714, 716 which are coupled across payload/source 718.

In operation, gaseous hydrogen fuel is channeled through hydrogen gas flow assembly 708 to the anode side of the fuel cell, while oxygen gas (oxygen or air) is channeled through the oxidant gas flow assembly 710 to the cathode side of the cell. At the anode 704, the platinum catalyst causes the hydrogen to split into positive hydrogen ions (protons) and negatively charged electrons. The porous silicon membrane 702 allows only the positively charged ions to pass through it to the cathode. The negatively charged electrons travel along the external circuit 712 to the cathode 706 creating an electrical current. At the cathode 706, the electrons and positively charged hydrogen ions combine with oxygen to form water, which then collects in a bottom of a cell and is removed.

Various changes may be made in the above disclosure. For example, as mentioned above, the noble metal catalysts may be coated directly on the pores of the porous silicon substrate membrane, or the porous silicon substrate membrane may be sandwiched between porous paper or carbon or graphite sheets impregnated with a noble metal. Also, other hydrogen fuel sources may be employed such as methanol and chemical hydrides.

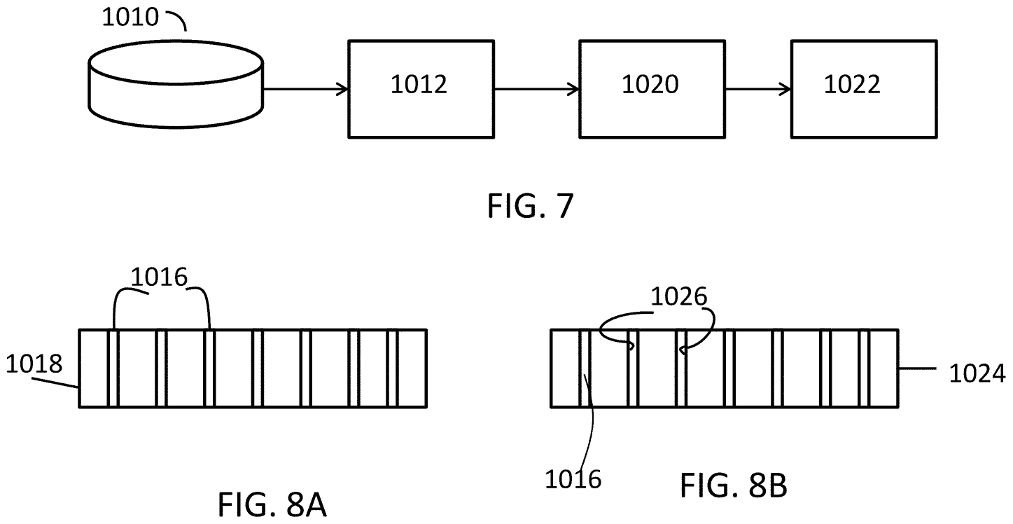

Referring now to FIGS. 7-14, an improved lithium ion rechargeable battery is formed according to the present disclosure as follows.

Referring in particular to FIG. 7, starting with a thin monocrystalline silicon wafer 10, typically 50-200 mil thick, the wafer 1010 is subjected to an electrochemical etching by applying uniform electrical field across the wafer while immersing the wafer in an etchant such a Dimethylformamide (DMF)/Dimethylsulfoxide (DMSO)/HF etchant (although other etchants are contemplated as a function of application), in an electrochemical immersion cell, in an electrochemical etching step 1012, to form micron sized through holes or pores 1016 through the wafer as shown in FIG. 8A. The growth of well-defined cylindrical micropores or through holes can be controlled by controlling etching conditions, i.e., etching current density, etchant concentration, temperature, silicon doping, etc., following the teachings of Santos et al., Electrochemically Engineered Nanoporous Material, Springer Series in Materials Science 220 (2015), Chapter 1, the contents of which are incorporated herein by reference.

The resulting pores have a high aspect ratio of length to cross-sectional diameter typically a length to diameter aspect ratio of >50:1. The resulting structure, shown in FIG. 8A comprises a porous silicon wafer 1018 having substantially cylindrical through holes or pores 1016 having a length of, e.g., 180 μm and a diameter of 1.6 i.e, an aspect ratio of 112.5:1 which is quite effective for use as electrode in a lithium ion battery as will be described below (although other aspect ratios are contemplated as a function of application). The walls of the resulting porous silicon wafer 1018 are then coated with a metal such as titanium, tungsten or cobalt in step 1020 (although other metals are contemplated as a function of application), and the metal coated porous silicon wafer is then subjected to a heat treatment in a heating step 1022 to convert the deposited metal to the corresponding metal silicide 1025 at heat treatment step 1022. There results a porous silicon substrate material 1024 in which the wall surfaces of the pores of the material are coated with a thin layer of a metal silicide material 1026 (FIG. 8A).

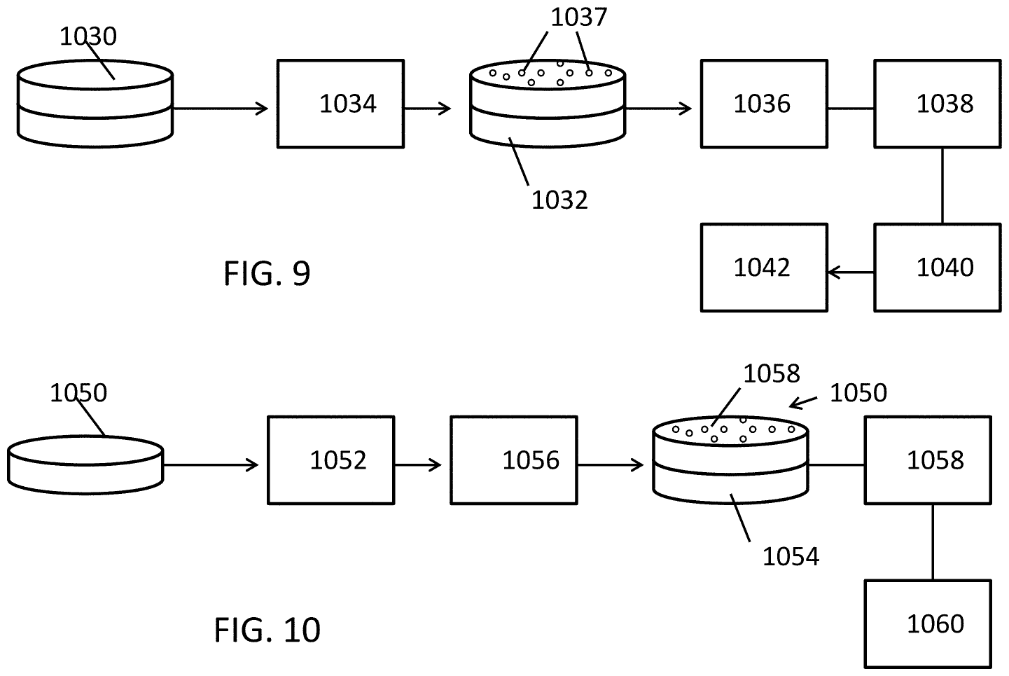

FIG. 9 illustrates an alternative embodiment of the present disclosure. The process starts with a silicon wafer 1030 to which is applied a thin metal layer 1032 on the back side of the wafer 1030 e.g., by sputtering in a step 1034. Metal layer 1032 on the backside of the wafer promotes improved electrical contact to the wafer. An electro chemical etching (step 1036) is used to form pores 1037 through the silicon wafer 1030. After porous silicon formation, a wet etch (step 1038) is used to remove the thin metal 1032 from the back side. The porous silicon wafer which is similar to the porous silicon substrate shown in FIG. 8A is then coated with metal in step 1040 and the metal converted to the silicide in a heating step 1042 similar to the first embodiment. There results a porous silicon substrate in which the surface of the wall surfaces of the pores are coated with a metal silicide similar to the porous silicon substrate shown in FIG. 8B.

FIG. 10 illustrates a third embodiment of the present disclosure. The process starts with a silicon wafer 1050 covered on one side in step 1052 with a sacrificial metal layer 1054 formed of, for example, a noble metal such as platinum (although other metals are contemplated as a function of application). The silicon wafer 1050 is then subjected to electrochemical etching by applying an uniform electrical field across the metal layer 1054 and substrate wafer 1050 as the wafer is immersed in an electrochemical cell containing an etchant such as HF and H₂O₂ (although other etchants are contemplated as a function of application), in step 1056, whereby to produce substantially uniform pores 1058 through the exposed portion of the silicon wafer substrate 1050 to the metal layer 1054. As before, the growth of well-defined cylindrical micropores or through holes can be controlled by controlling etching conditions, i.e., etching current density, etching concentration, temperature, silicon doping, etc., again following the teachings of Santos et al. Alternatively, micropore or through hole formation can be controlled by covering selected portions of the silicon wafer with a nanoporous anodic alumina mask (although other masks are contemplated as a function of application). Self-ordered nano porous anodic alumina is basically a nanoporous matrix based on alumina that features closed-packed arrays of hexagonally arranged cells, at the center of which a cylindrical nanopore grows perpendicularly to the underlying aluminum substrate. Nanoporous anodic alumina may be produced by electrochemical anodization of aluminum, again following the teachings of Santos et al. the teachings of which are incorporated herein by reference. The sacrificial metal layer 1054 can then be removed in a step 1058 leaving a porous silicon wafer having substantially cylindrical through holes or pores having a length to diameter aspect ratio of >50:1, i.e., similar to the porous silicon substrate shown in FIG. 8A. The porous silicon substrate is then coated with metal in step 1058, and heated to convert the metal to the metal silicide in step 1060, whereby a porous silicon substrate in which the wall surfaces of the pores are coated with metal silicide similar to FIG. 8B is produced.

Porous silicon wafers as produced above are assembled into a lithium ion battery as will be described below.

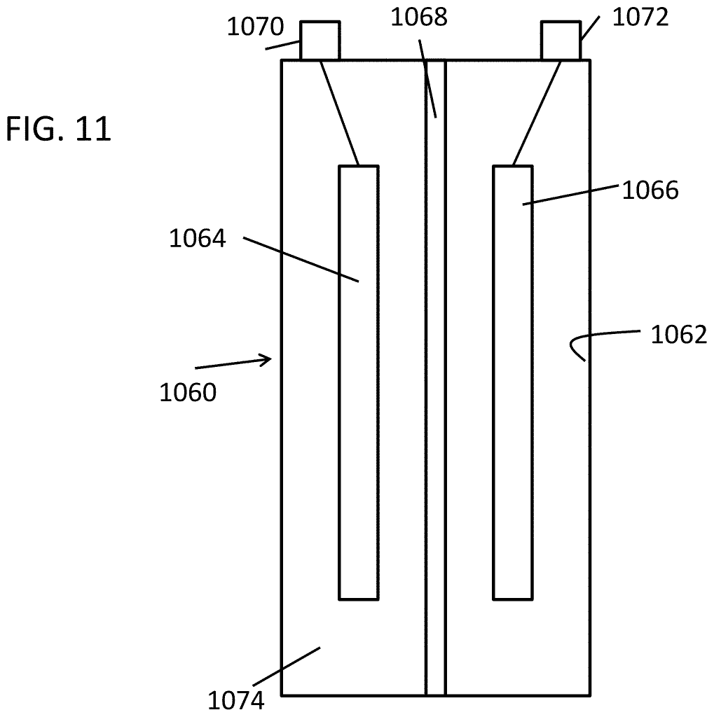

FIG. 11 shows a lithium ion battery 1060 in accordance with the present disclosure. Battery 1060 includes a case 1062, an anode 1064 formed of a metal silicide coated porous silicon substrate formed as above described, and a cathode 66 formed, for example, of graphite, separated by a membrane or separator 1068. Anode 1064 and cathode 1066 are connected respectively, to external tabs 1070, 1072, respectively. A lithium containing electrolyte 1074, for example, lithium cobalt oxide is contained within the battery 1060 (although other electrolytes are contemplated as a function of application).

Both the anode and cathode allow lithium ions to move in and out of their structures by a process called insertion (intercalation) or extraction (deintercalation), respectively. During discharge, the positive lithium ions move from the negative electrode (anode) to the positive electrode (cathode) forming a lithium compound through the electrolyte while the electrodes flow through the external circuit in the same direction. When the cell is charging, the reverse occurs, with the lithium ions and the electrodes moving back into the negative electrode with a net higher energy stake.

A feature an advantage of the present disclosure is that the anode may be made physically larger, i.e., thicker than the cathode. The increased thickness porous structure of the anode allows protons more time to move into the electrode matrix. Also, less lithium electrolyte is required for similar energy storage. And, since the protons move more slowly into the anode, this permits a faster charge and discharge rate without a danger of fractures or pulverization of the electrode.

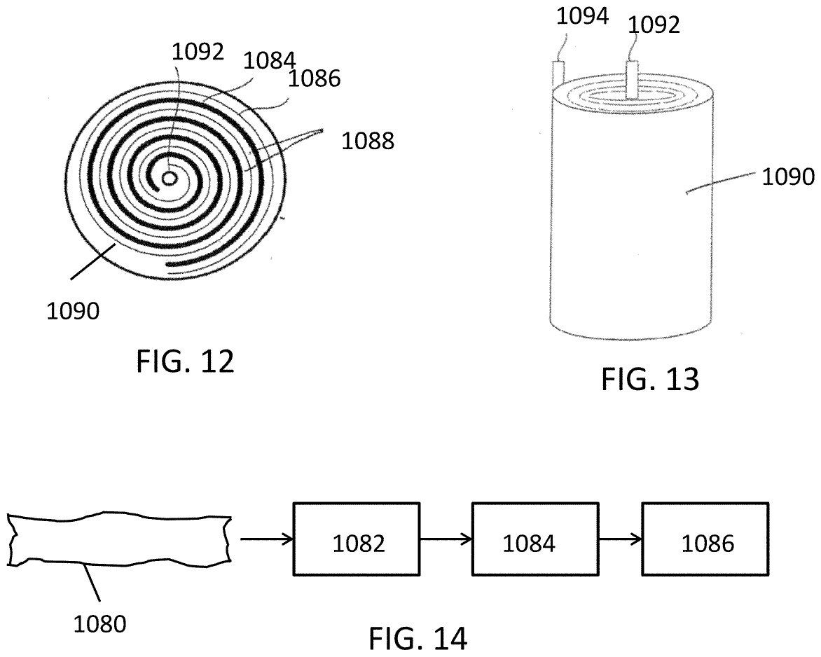

Changes may be made in the above disclosure without departing from the spirit and scope thereof. For example, while the anode production has been described as being formed from monocrystalline silicon wafers, monocrystalline silicon ribbon advantageously may be employed for forming the anode. Referring to FIG. 12, employing silicon ribbon 1080 permits a continuous process in which ribbon is run through an electrochemical etching bath 1082 to form pores through the ribbon, and then from there through a metal coating station 1084 and from there a heat treating station 1086 to form metal silicide on the surfaces of the walls of the pores. The resultant porous silicon metal silicide coated ribbon may then be used to form a lithium ion battery using standard roll manufacturing techniques. For example, referring to FIG. 13, the silicide coated porous silicon ribbon anode electrode 1084 may be assembled in a stack with cathode electrode 86 between separator sheets 1088. The electrodes 1084, 1086 and separator sheets 88 are wound together in a jelly roll and then inserted in a case 1090 with a positive tab 1092 and negative tab 1094 extending from the jelly roll. The tabs may then be welded to an exposed portion of the electrodes 1084, 1086, the case 1090 filled with electrolyte, and the case 1090 sealed. There results a high capacity lithium ion rechargeable battery in which the anode material comprises porous metal silicide coated porous silicon ribbon capable of repeated charges and discharges without adverse effects.

Still other changes are possible. For example, rather than using monocrystalline silicon chips or monocrystalline silicon ribbon, the silicon may be polysilicon silicon or amorphous silicon. Also, while tungsten cobalt and titanium have been described as the preferred metals for forming the metal silicides, other conventionally used in forming advantageously may be employed including silver (Ag), aluminum (Al), gold (Au), palladium (Pd), platinum (Pt), Zn, Cd, Hg, B, Ga, In, Th, C, Si, Ge, Sn, Pb, As, Sb, Bi, Se and Te. Also, while LiPF₆ and LiBf₄ have been described as useful electrolytes, other electrolytes conventionally used with lithium ion batteries including but not limited to lithium cobalt oxide (LiCoO₂). It should be appreciated that other metals and/or electrolytes are contemplated as a function of application.

What is claimed:

1. A Proton Exchange Membrane Fuel Cell (PEMFC) comprising a separator membrane element formed of a porous silicon wafer.

2. The PEMFC of claim 1, wherein pores of the porous silicon wafer are substantially cylindrical through holes, and/or wherein the cylindrical through holes have a length to diameter aspect ratio of >50:1.

3. The PEMFC of claim 1, wherein surfaces of pores of the porous silicon wafer are coated, at least in part, with a noble metal, preferably a noble metal selected from the group consisting of silver, gold, platinum, rhodium, iridium, palladium, ruthenium and osmium.

4. The PEMFC of claim 1, wherein the porous silicon wafer is sandwiched between paper, carbon or graphite sheets impregnated with a noble metal, preferably a noble metal selected from the group consisting of silver, gold, platinum, rhodium, iridium, palladium, ruthenium and osmium.

5. A Proton Exchange Membrane Fuel Cell (PEMFC), comprising:
an electrical assembly comprising positive and negative electrodes separated by a porous membrane, wherein the porous membrane comprises a porous silicon wafer.

6. The PEMFC of claim 5, wherein pores of the porous silicon wafer are substantially cylindrical though holes, and/or have a length to diameter aspect ratio of >50:1.

7. The PEMFC of claim 5, wherein the pores of the porous membrane are coated, at least in part, with a noble metal catalyst, preferably a noble metal selected from the group consisting of silver, gold, platinum, rhodium, iridium, palladium, ruthenium and osmium.

8. The PEMFC of claim 5, wherein the porous silicon wafer is sandwiched between paper, carbon or graphite sheets impregnated with a noble metal, preferably a noble metal selected from the group consisting of silver, gold, platinum, rhodium, iridium, palladium, ruthenium and osmium.

9. The PEMFC of claim 5, comprising a membrane formed by method of forming the membrane, comprising:
providing a silicon wafer;
etching through holes extending through at least a portion of the wafers, wherein the through holes have a length to diameter aspect ratio of >50:1; and
coating surface of the holes at last in part with a noble metal, or sandwiching the etched silicon wafer between paper, carbon or graphite sheets impregnated with a noble metal, wherein the noble metal preferably is selected from the group consisting of silver, gold, platinum, rhodium, iridium, palladium, ruthenium and osmium.

10. A lithium ion battery, comprising:
a cathode electrode;
an anode electrode formed of a porous silicon substrate in which surfaces of the pores of the porous silicon substrate are coated at least in part with a metal silicide;
a separator element disposed between the cathode and the anode; and
an electrolyte.

11. The lithium ion battery of claim 10, wherein the silicon substrate comprises monocrystalline silicon, polycrystalline silicon, or amorpohous silicon.

12. The lithium ion battery of claim 10, wherein the metal silicide coating is selected from the group consisting of TiSi₂, CoSi₂ and WSi₂.

13. The lithium ion battery of claim 10, wherein the pores have a length to diameter aspect ratio of >50:1.

14. The lithium ion battery of claim 10, wherein the electrolyte is selected from the group consisting of LiPF₆, LiBF₄ and LiCoO₂.

15. The lithium ion battery of claim 10, wherein an anode electrode comprises a substrate formed of porous silicon in which surface areas of the pores are coated at least in part with a metal silicide.

16. The lithium ion battery of claim 15, wherein the silicon substrate comprises monocrystalline silicon, polycrystalline silicon, or amorphous silicon.

17. The lithium ion battery of claim 15, wherein the pores have a length to diameter aspect ratio of >50:1.

18. The lithium ion battery of claim 15, wherein the metal silicide is selected from the group consisting of TiSi₂, CoSi₂ and WSi₂.
